(19) United States
(12) Patent Application Publication
(10) Pub. No.: US 2024/0257526 A1
(43) Pub. Date: Aug. 1, 2024

(54) MONITORING METHOD AND APPARATUS, AND UNMANNED VEHICLE AND MONITORING DEVICE

(71) Applicant: SZ DJI TECHNOLOGY CO., LTD., Shenzhen (CN)

(72) Inventors: Zhenhao HUANG, Shenzhen (CN); Zhaohui FANG, Shenzhen (CN); Yuetao MA, Shenzhen (CN)

(21) Appl. No.: 18/631,437

(22) Filed: Apr. 10, 2024

Related U.S. Application Data
(63) Continuation of application No. PCT/CN2021/123137, filed on Oct. 11, 2021.

(51) Int. Cl. G06V 20/52; G05D 1/242; G05D 1/243; G05D 1/686; G05D 105/85; G05D 109/20; G05D 111/10; G06T 7/73; G06V 20/17

(52) U.S. Cl. CPC G06V 20/52; G05D 1/2424; G05D 1/2435; G05D 1/2437; G05D 1/686; G06T 7/73; G06V 20/17; G05D 2105/85; G05D 2109/20; G05D 2111/14; G06T 2207/10032; G06T 2207/30232; G06T 2207/30244

(57) ABSTRACT

A monitoring method includes identifying a monitoring target and a warning object in space according to data collected by a data collection apparatus, obtaining position information of the monitoring target and the warning object, determining a warning area based on the position information of the monitoring target, and generating warning information based on a position relationship between a position of the warning object and the warning area.

### CROSS-REFERENCE TO RELATED APPLICATION

This application is a continuation of International Application No. PCT/CN2021/123137, filed Oct. 11, 2021, the entire content of which is incorporated herein by reference.

### TECHNICAL FIELD

The present disclosure relates to the unmanned vehicle (UV) technology field and, more particularly, to a monitoring method and apparatus, a UV, and a monitoring device.

### BACKGROUND

In security patrol technology, cameras are often installed within secured areas to monitor the secured areas. However, due to blind zones of the cameras, additional patrol personnel are often required to inspect the secured areas to prevent potential security incidents in the secured areas. The security patrol mainly depends on human patrols and lacks flexibility and intelligence. In some emergency scenarios, analysis and decision are not able to be accurately and quickly performed on the emergency incidents.

### SUMMARY

In accordance with the disclosure, there is provided a monitoring method. The method includes identifying a monitoring target and a warning object in space according to data collected by a data collection apparatus, obtaining position information of the monitoring target and the warning object, determining a warning area based on the position information of the monitoring target, and generating warning information based on a position relationship between a position of the warning object and the warning area.

Also in accordance with the disclosure, there is provided a monitoring apparatus, including one or more processors and one or more memories. The one or more memories store an executable instruction that, when executed by the one or more processors, causes the one or more processors to identify a monitoring target and a warning object in space according to data collected by a data collection apparatus, obtain position information of the monitoring target and the warning object, determine a warning area based on the position information of the monitoring target, and generate warning information based on a position relationship between a position of the warning object and the warning area.

### BRIEF DESCRIPTION OF THE DRAWINGS

FIG. 1 is a schematic flowchart of a monitoring method consistent with an embodiment of the present disclosure.

FIG. 2 is a schematic flowchart of another monitoring method consistent with an embodiment of the present disclosure.

FIG. 3 is a schematic flowchart of another monitoring method consistent with an embodiment of the present disclosure.

FIG. 4 is a schematic flowchart of another monitoring method consistent with an embodiment of the present disclosure.

FIGS. 5A and 5B are schematic diagrams showing a position information acquisition method for a monitoring target consistent with an embodiment of the present disclosure.

FIG. 6 is a schematic flowchart of another monitoring method consistent with an embodiment of the present disclosure.

FIG. 7 is a schematic flowchart of another monitoring method consistent with an embodiment of the present disclosure.

FIG. 8 is a schematic diagram showing a road sign consistent with an embodiment of the present disclosure.

FIGS. 9A and 9B are schematic diagrams showing a warning area consistent with an embodiment of the present disclosure.

FIGS. 10A and 10B are schematic diagrams showing another warning area consistent with an embodiment of the present disclosure.

FIG. 11 is a schematic diagram showing another warning area consistent with an embodiment of the present disclosure.

FIG. 12 is a schematic flowchart of another monitoring method consistent with an embodiment of the present disclosure.

FIGS. 13A to 13C are schematic diagrams showing a position relationship between a warning object and a warning area consistent with an embodiment of the present disclosure.

FIG. 14 is a schematic structural diagram of a monitoring apparatus consistent with an embodiment of the present disclosure.

FIG. 15 is a schematic structural diagram of a UV consistent with an embodiment of the present disclosure.

FIG. 16 is a schematic structural diagram of a monitoring device consistent with an embodiment of the present disclosure.

### DETAILED DESCRIPTION OF THE EMBODIMENTS

The technical solution of embodiments of the present disclosure is described in detail in connection with the accompanying drawings. Described embodiments are some embodiments of the present disclosure, not all embodiments. Based on embodiments of the present disclosure, all other embodiments obtained by those of ordinary skill in the art without creative efforts are within the scope of the present disclosure.

In the security patrol technology, cameras are often installed within secured areas to monitor the secured areas. However, due to the blind zones of the cameras, additional patrol personnel are often required to inspect the secured areas to prevent potential security incidents. Security patrols mainly rely on human intervention and lack of flexibility and intelligence. Additionally, in scenarios such as fires, natural disasters, and traffic accidents, analysis and decision cannot be accurately and quickly performed on the emergency incidents.

An unmanned vehicle (UV), such as an unmanned aircraft, an unmanned boat, or an unmanned car, can have great mobility and is not restricted by terrain. Leveraging the mobility of the UV, if the UV is applied in security patrol technology, the flexibility and intelligence of security patrols can be greatly improved.

However, applying the UV in security patrol scenarios faces several technical challenges. For example, in the above solution of monitoring the secured area using a camera, whether the secured area is intruded can be determined by comparing whether pixels change in the image collected by the camera relative to the previous image. Due to the mobility of the UV, when the position of the UV changes, the image collected by the UV can be different from the previous image. Thus, whether the secured area is intruded cannot be determined by comparing whether the pixels change.

In addition, in some solutions, after the UV collects a plurality of images of a certain area, pose information can be written in the image. After the UV returns, based on ground-end (e.g., a terminal such as a personal computer) processing software, a coverage area of the image can be projected onto a flat plane, other information such as the position information of a monitored object can be obtained according to the projected image. Meanwhile, the above method needs to be performed through the ground-end software after the UV returns. Thus, the timeliness can be poor. Analysis and decision cannot be quickly performed for some emergency incidents. After the processing of the software, the monitored object may need to be determined manually. The position information of the monitored object may need to be measured manually. Automatic recognition, machine learning, and deeper analysis cannot be performed.

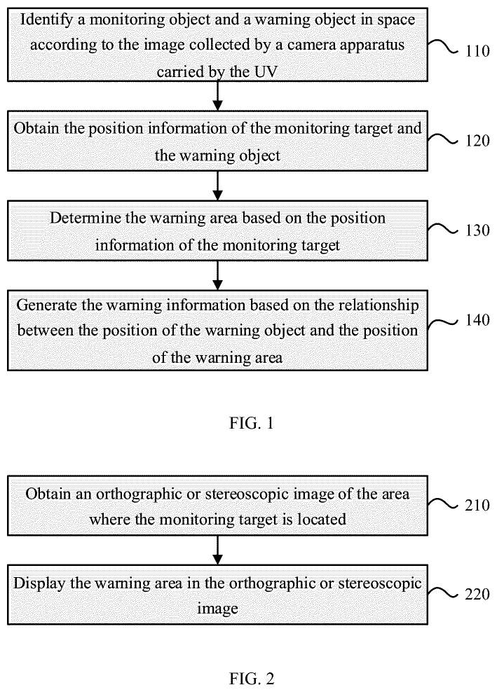

Thus, the present disclosure provides a monitoring method, including the following processes shown in FIG. 1.

At 110, a monitoring target and a warning object are identified in space according to the image collected by a camera apparatus carried by the UV. The camera apparatus can be an example of a data collection apparatus, and the image can be an example of data collected by the data collection apparatus.

At 120, the position information of the monitoring target and the warning object is obtained.

For example, the position information can be determined based on the pose of the camera when collecting the image. In some embodiments, the image collected by the camera carried by the UV can be obtained. An image area of the monitoring target and the warning object can be identified in the image. The position information of the monitoring target and the warning object can be obtained based on the pose of the camera when collecting the image and the image area.

As another example, the position information can be determined based on another distance sensor of the UV, e.g., binocular vision, LiDAR, or millimeter-wave radar.

At 130, the warning area is determined based on the position information of the monitoring target.

At 140, the warning information is generated based on the position relationship between the position of the warning object and the warning area.

Additionally, in some scenarios, the image collected by the camera apparatus carried by the UV can be obtained, and the image areas of the monitoring target and the warning object can be identified in the image. Based on the pose of the camera apparatus when collecting the image and the image area, the position information of the monitoring target and the warning object can be obtained. The warning area can be determined based on the position information of the monitoring target. The warning information can be generated based on the position relationship between the position of the warning object and the warning area.

In addition, in some embodiments, the position information of the monitoring target and the warning object can be determined according to the images captured by the camera apparatus carried by the UV and the pose of the camera apparatus when capturing the image. The warning area can be determined based on the position information of the monitoring target. The warning information can be generated based on the position relationship between the position of the warning object and the warning area.

The monitoring method of the present disclosure can be applied to a UV. The UV can include an unmanned aircraft, an unmanned boat, and an unmanned vehicle. Taking the unmanned aircraft as an example, the UV can recognize the monitoring target and the warning object according to the image collected by the camera apparatus carried by the UV, determine the position information of the monitoring target and the warning object based on the pose of the camera apparatus when collecting the image, generate the warning area based on the position information of the monitoring target, and generate warning information based on the position information between the position of the warning object and the warning area.

Additionally, the above method can be further applied to a monitoring device communicating with the UV. The monitoring device can include a remote controller and a terminal device having a video display function, such as a smartphone, a tablet, a PC, a wearable device, etc. The monitoring device can obtain the image captured by the camera apparatus carried by the UV via a communication link established with the UV, identify the monitoring target and the warning object, and obtain the position information of the monitoring target and the warning object. The position information can be determined by the UV based on the pose of the camera apparatus when collecting the image, and can be sent to the monitoring device by the UV. The UV can also send the pose information when the camera apparatus collects the image to the monitoring device. The monitoring device can determine the position information of the monitoring target and the warning object based on the pose information. Then, the monitoring device can generate the warning area based on the position information of the monitoring target, and generate the warning information based on the position relationship between the position of the warning object and the warning area. In some other embodiments, in the method, some processes can be performed at the UV, and some embodiments can be performed at the monitoring device.

In addition, the camera apparatus carried by the UV can be a regular camera, a professional camera, an infrared camera, a multispectral camera, etc., which is not limited here.

In the monitoring method of the present disclosure, the solution can be provided based on the image collected by the UV and through the position information of the monitoring target and the warning object. The monitoring target can include a target representing a dangerous source, such as an oil tank, a gas station, or a fire area, which needs to be monitored. The warning object can include an object, which should be away from the dangerous source, such as a pedestrian, a vehicle, an animal, a mobile object with a fire source (e.g., a pedestrian who is smoking), etc. The position information of the monitoring target and the warning object can include actual geographic position information. The monitoring target and the warning object can be identified in each frame image collected by the UV. The warning area can be drawn according to the position information of the monitoring target. Then, according to the position relationship between the warning object and the warning area, the warning information can be generated. For example, when the warning object approaches and enters the warning area, the warning information can be generated. The warning information can include information in a format such as text, language, and video. The warning information can be displayed through a plurality of methods. For example, the warning information can be output through the user interface of the monitoring device, can be played by a playback module of the monitoring device, or can be output by other devices. For example, the warning information can be broadcast by an external speaker, and the warning information can be displayed by controlling a warning indicator to flash. In the above solution, with the mobility of the UV, the flexibility and the intelligence of the security patrols can be greatly increased for the monitoring target. Meanwhile, the above solution can be performed in a UV operation, there is no need to wait until the UV returns to perform processing on the image using the ground-end software. Thus, in some emergency scenarios, the analysis and the decision can be quickly performed on the emergency incidents through the above solution.

In some embodiments, to better display the monitoring target and the warning area to monitoring personnel, the monitoring method of the present disclosure further includes the following processes shown in FIG. 2.

At 210, an orthographic or stereoscopic image of the area where the monitoring target is located is obtained. The area where the monitoring target is located is also referred to as a “target area”

At 220, the warning area is displayed in the orthographic or stereoscopic image.

Methods for displaying the monitoring target and the warning area can include displaying the monitoring target and the warning area in the orthographic image of the area where the monitoring target is located, displaying the monitoring target and the warning area in the stereoscopic image of the area where the monitoring target is located, or a combination of thereof.

For the first display method, the orthographic image can be an image under an orthogonal projection, which has advantages such as a large amount of information, and being easy to interpret. The monitoring target and the warning area can be displayed to the monitoring personnel through the orthographic image. Thus, the monitoring personnel can obtain the monitoring target and the warning area.

For the first display method, the orthographic image can be the image under the orthogonal projection, which has advantages such as a large amount of information and easy to read. The monitoring target and the warning area can be displayed to the monitoring personnel through the orthographic image. Thus, the monitoring personnel can obtain information of the monitoring target and the warning area.

The acquisition method for the orthographic image can include obtaining the orthographic image through image synthesis or obtaining the orthographic image through a three-dimensional model.

For the first acquisition method, since the image collected by the camera apparatus is the central projection, the orthographic image can be the image synthesized by the image collected by the camera apparatus. In some embodiments, the orthographic image can be synthesized by the image collected based on the pose processing of the camera apparatus.

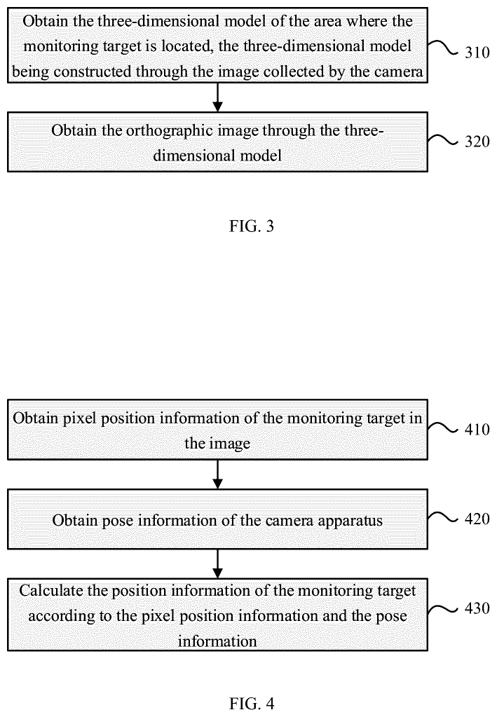

For the second acquisition method, the acquisition method of the orthographic image includes processes shown in FIG. 3.

At 310, the three-dimensional model of the area where the monitoring target is located is obtained. The three-dimensional model is constructed through the image collected by the camera.

At 320, the orthographic image is obtained through the three-dimensional model.

In some embodiments, the image collected by the camera apparatus can be used for synthesis or to construct the three-dimensional model. In some embodiments, the UV collecting the image and the UV executing the monitoring method above can be the same UV or different UVs. For example, one or more UVs can be assigned to fly to the area where the monitoring target is located to collect several images, and synthesis can be performed on the collected images, or the three-dimensional model can be constructed at the ground end. Then, another UV can be assigned to perform the monitoring method.

For the second display method, the warning area can be displayed in the stereoscopic image, which can more visually and three-dimensionally display the warning area and the surroundings of the warning area to monitoring personnel. In some embodiments, the stereoscopic image can be obtained using the three-dimensional model. The three-dimensional model configured to obtain the stereoscopic image may be the same or different from the three-dimensional model configured to obtain the orthographic image. For example, the three-dimensional model configured to obtain the stereoscopic image can be more detailed than the three-dimensional model configured to obtain the orthographic image.

By displaying the warning area in the orthographic or stereoscopic image, the monitoring personnel can better know the information around the warning area.

In the image collected by the camera apparatus, an edge area of the image often has significant distortion, while the center area can be considered to have no distortion. If the monitoring target is located at an edge position of the image, deformation can occur in the image, which results in inaccurate position information. Therefore, to ensure the accuracy of the obtained position information of the monitoring target, the position information of the monitoring target and the warning object can be obtained when the monitoring target is in the center area of the image. In some embodiments, in addition to keeping the monitoring target in the center area, distortion correction processing can be performed on the image first before calculating the position information of the monitoring target and the warning object.

The position information of the monitoring target and the warning object can be determined based on the pose of the camera apparatus when collecting the image. In some embodiments, the position information of the monitoring target is obtained through the following processes shown in FIG. 4.

At 410, pixel position information of the monitoring target in the image is obtained.

At 420, the pose information of the camera apparatus is obtained.

At 430, the position information of the monitoring target is calculated according to the pixel position information and the pose information.

The camera apparatus can include a lens and a sensor, which is a photosensitive device, and other necessary assemblies. A distance from the lens to the sensor can be focal length f. The pose information of the camera apparatus can be the pose information of the lens or the lens optical center. The pose information can include position information and/or attitude information. The position information can include the world coordinates of the camera apparatus, while the attitude information can include a pitch angle, a roll angle, and a yaw angle of the camera apparatus.

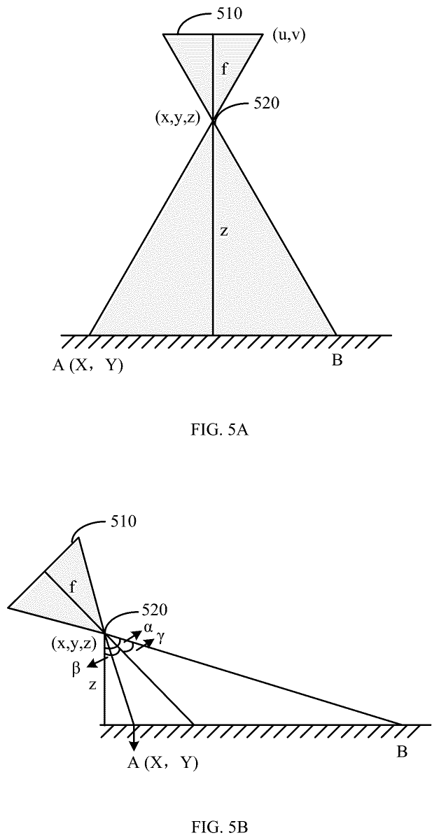

As shown in FIGS. 5A and 5B, when the camera apparatus carried by the UV is operating, a projection area of a sensor 510 on the ground is AB. By obtaining the pose information of the camera apparatus when collecting the image and according to a geometric projection relationship, the position information of any pixel point of the sensor projected onto the ground can be obtained.

As shown in FIG. 5A, when the camera apparatus is in orthographic position, i.e., the sensor 510 is parallel to the ground, according to the pose information (x, y, z) of the lens 520 and the geometric projection relationship, the position information (X, Y) of projection point A of any one pixel (u, v) on the ground can be obtained with the center point of the sensor 510 as the origin. The relationships between the position information (X, Y) of projection point A and the pixel point (u, v) and the pose information (x, y, z) of the lens 520 are as follows.

$$\\ X = x + z * u * pixelsize / f$$

$$\\ Y = y + z * v * pixelsize / f$$

where pixelsize is a size of a single pixel.

As shown in FIG. 5B, when the camera apparatus is in oblique photography, i.e., the sensor 510 is not parallel to the ground, according to the pose information (x, y, z) of the lens 520 and the geometric projection relationship, the position information (X, Y) of projection point A on the ground can be obtained for any pixel point (u, v) with the center point of the sensor 510 as the origin. The relationships between the position information (X, Y) of projection point A and the pixel point (u, v) and the pose information (x, y, z) of the lens 520 are as follows.

$$\\ X = x + z * tan ( α )$$

$$\\ Y = y + z * v * pixelsize / f$$

where α=β+γ, β is obtained from the attitude information of the camera apparatus, and γ=arctan(u*pixelsize/f), and pixelsize is a size of a single pixel.

Through the above method, the position information of any pixel point of the sensor at the ground projection point can be obtained when the camera apparatus is in orthographic photography or oblique photography. Taking the monitoring target as an example, embodiments of how to obtain the position information of the monitoring target are described. The position information of the warning object can also be obtained using the above method.

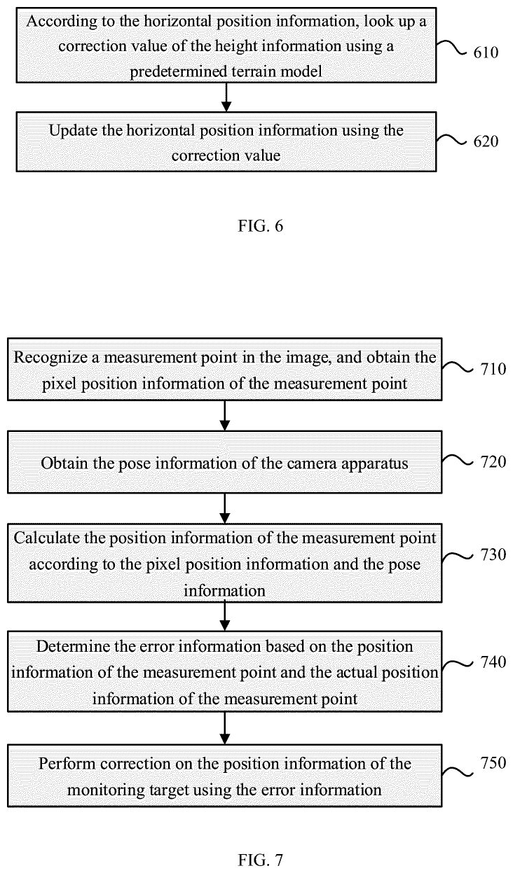

In some embodiments, the position information of the monitoring target can include horizontal position information and height position information. Obtaining the position information of the monitoring target also includes the processes shown in FIG. 6.

At 610, according to the horizontal position information, a correction value of the height information is looked up using a predetermined terrain model.

At 620, the horizontal position information is updated using the correction value.

The horizontal position information (X, Y) of the monitoring target can be obtained through the processes shown in FIG. 4. The predetermined terrain model can be configured to obtain the height position information of the monitoring target, which can include a Digital Elevation Model (DEM) or a Digital Surface Model (DSM). According to the horizontal position information (X, Y), correction value H of the height information corresponding to the horizontal position can be looked up using DEM or DSM. Thus, the position information (X, Y, H) of the monitoring target can be obtained.

As described above, the horizontal position information (X, Y) of the monitoring target can be calculated according to the pose information of the camera apparatus. z in the pose information can represent a relative height of the current position of the camera apparatus relative to a start-off point (home point). In some embodiments, if the home point and the projected position of the monitoring target on the ground are not at the same horizontal height, using relative height z of the current position of the camera apparatus relative to the home point to calculate the horizontal position information (X, Y) of the monitoring target can introduce an error. To eliminate the error, correction value H of the height information can be used to update the horizontal position information (X, Y).

In addition to using correction value H of the height information to correct the position information of the monitoring target, the position information of the monitoring target can also be corrected using the processes shown in FIG. 7.

At 710, a measurement point is recognized in the image, and the pixel position information of the measurement point is obtained.

At 720, the pose information of the camera apparatus is obtained.

At 730, the position information of the measurement point is calculated according to the pixel position information and the pose information.

At 740, the error information is determined based on the position information of the measurement point and the actual position information of the measurement point.

At 750, correction is performed on the position information of the monitoring target using the error information.

The position information of the monitoring target can be corrected using the known actual position information of the measurement point. After the error information between the actual position information of the measurement point and the position information of the projection point of the measurement point on the ground is determined, the correction can be performed on the position information of the monitoring target. The position information of the projection point of the measurement point on the ground can be calculated according to the pixel position information of the measurement point in the image, the pose information of the camera apparatus, and the projection relationship.

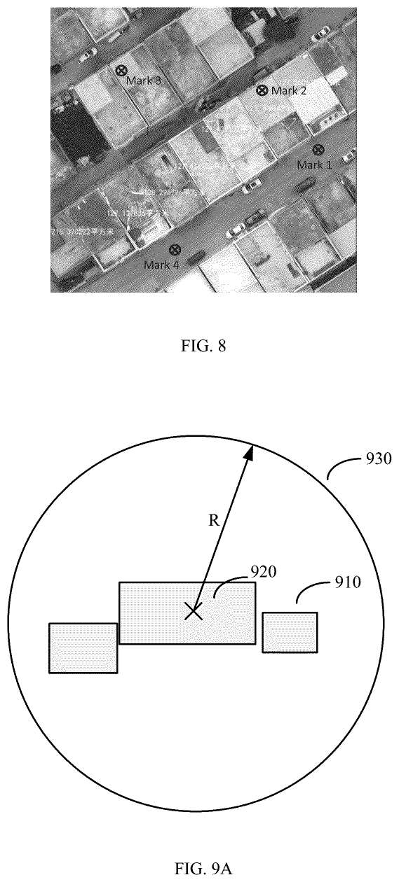

In some embodiments, the measurement point can be a predetermined road sign with known actual position information. In some embodiments, the road signs can be displayed in the image (including the orthographic image or the stereoscopic image) shown to the monitoring personnel. In some embodiments, as shown in FIG. 8, the orthographic image includes four road signs with known actual position information distributed on the ground, including Mark 1, Mark 2, Mark 3, and Mark 4. Taking road sign Mark 1 as an example, the actual position of road sign Mark 1 is (X1, Y1, H1). The position information (X1proj, Y1proj, H1proj) of the projection point of road sign Mark 1 on the ground can be calculated through the pose information of the camera apparatus and the pixel position information of road sign Mark 1 in the image. As such, the error information V1 between the actual position (X1, Y1, H1) of Mark 1 and the position (X1proj, Y1proj, H1proj) of the projection point of Mark 1 on the ground can be obtained, where V1 is a vector. For other road signs, error information V2, V3, and V4 can be obtained in the same method. For pixels near the road signs, for example, pixel points within the predetermined pixel distance from the road sign, the correction can be performed on the position information of the projection point of the pixel point on the ground according to the error information. For the pixel points between two road signs, interpolation can be performed on the error information. The correction can be performed on the position information of the projection point of the pixel point on the ground using the interpolation value. For the method for obtaining the interpolation value, reference can be made to related technology, which is not limited here.

In some embodiments, the actual position information of the measurement point can also be determined based on a laser radar device carried by the UV. The laser radar device carried by the UV can be configured to obtain point cloud information of the measurement point, and the actual position information of the measurement point can be determined based on the point cloud information. In some embodiments, the laser radar carried by the UV can be a low-cost laser radar that outputs a sparse point cloud. In some embodiments, the laser radar and the sensor of the camera apparatus can be precisely calibrated, and an external parameter matrix of describing the position relationship between the laser radar and the sensor can be determined. Meanwhile, an internal parameter matrix of the sensor can also be calibrated in advance. Thus, a conversion relationship between the position information (X, Y, Z) of the measurement point determined through the point cloud information and the corresponding pixel point (u, v) of the measurement point on the sensor can be constructed. Meanwhile, the position information (X1proj, Y1proj, H1proj) of the projection point of the pixel point (u,v) on the ground can be obtained. By comparing the position information (X, Y, Z) determined through the point cloud information with the position information (X1proj, Y1proj, H1proj) of the projection point, the error information can be determined, and the correction can be performed on the position information of the projection point using the error information. For the laser radar with a plurality of heads, a plurality of laser beams can be emitted. Thus, the actual position information of a plurality of measurement points can be obtained. For pixel points between the measurement points, interpolation can be performed on the error information of the two measurement points. The correction can be performed on the position information of the projection points of the pixel points on the ground using the interpolation value. For the method for obtaining the interpolation value, reference can be made to the related technology, which is not limited here.

In some embodiments, the actual position information of the measurement point can also be calculated based on a visual algorithm. Features of the measurement point can be extracted from images captured at different times. A collinear equation can be constructed. Then, the actual position information of the measurement point can be calculated using the visual algorithm. The error information can be determined based on the actual position information of the measurement point and the position information of the project point of the measurement point on the ground. The correction can be performed on the position information of the projection point using the error information. For the pixel points between the measurement points, the interpolation can be performed on the error information of the two measurement points. The correction can be performed on the position information of the projection point of the pixel point on the ground using the interpolation value. For the method for obtaining the interpolation value, reference can be made to the related technology, which is not limited here.

According to the above, the position information of the monitoring target can be obtained and corrected. In some embodiments, the position information of the warning object can be obtained in any method of embodiments of the present disclosure.

After the position information of the monitoring target is obtained, the warning area can be determined based on the position information. The method for determining the warning area can be set as needed. For example, according to the predetermined distance, an area obtained by expanding from the position where the monitoring target is located outward for the predetermined distance can be used as the warning area. The predetermined distance can be set flexibly. In some other embodiments, the warning area can be determined in connection with the environment around the monitoring target or other objects. In some other embodiments, the monitoring target can have a certain size and occupy a certain area on the ground. The position information of the monitoring target can include a determined position in the monitoring target. The warning area can be determined according to the determined position and the predetermined area model. The determined position of the monitoring target can be the center position of the monitoring target or a non-center position of the monitoring target. The predetermined area model can include dimension information and shape information of the warning area. The shape information can include a circular area, and the dimension information can include an area radius. The shape information can include a rectangular area, and the dimension information can include the length and width of the area. The shape information can further include a sector area, and the dimension information can include an area arc angle and an area radius. In some embodiments, the shape information can further include any other shape, which is not limited here.

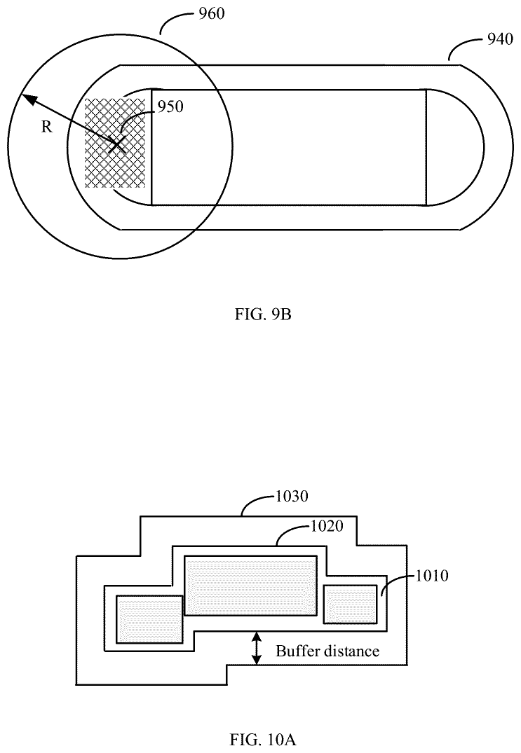

FIG. 9A shows a warning area. If the monitoring target is a plant area 910 formed by three rectangles, a circular area with the center position 920 of the plant area 910 as the center and R as the radius can be determined as the warning area 930 according to the center position 920 of the plant area 910 and the predetermined area model.

As another example, in the warning area shown in FIG. 9B, in a scenario in which a part of a sports field is on fire, the monitoring target is the sports field 940. An infrared detector carried by the UV can detect that the temperature is abnormally high in the left area 950 of the sports field 940. Thus, the center position of the left area 950 can be used as the determined position, and a circular area with the determined position as the center and R as the radius can be determined as the warning area.

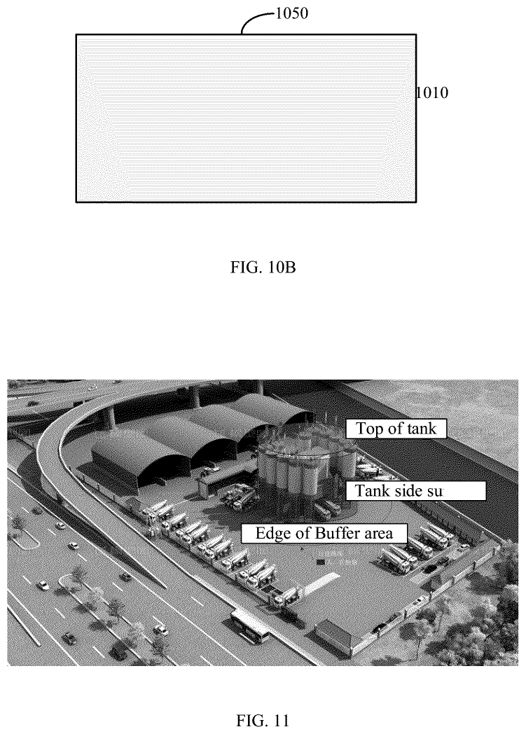

In some embodiments, the position information of the monitoring target can include the edge position of the monitoring target. The warning area can be determined according to the edge position and a predetermined buffer distance. In some embodiments, feature extraction and machine learning can be performed on the image collected by the camera apparatus to recognize the edge of the monitoring target. The edge position can be determined according to feature points at an outer surface of the monitoring target. The edge of the monitoring target can include a contour or a polygon. For example, in the warning area as shown in FIG. 10A, a plant area can be the monitoring target 1010, and the edge can be the contour 1020 of the monitoring target 1010. Thus, according to the edge position and the predetermined buffer distance, the warning area 1020 can be determined. As another example, in the warning area shown in FIG. 10B, the edge of the monitoring target 1010 can be the rectangle 1040. Thus, the warning area 1050 can be determined according to the edge position and the predetermined buffer distance.

In the warning area shown in FIG. 11, the monitoring target is a tank. By performing the feature extraction and machine learning on the image collected by the camera apparatus, the top and the side edge range of the tank can be recognized to determine the edge of the tank. Then, the position information of the projection point of an edge pixel can be obtained on the ground to obtain an edge position set {POS}i of the tank. For an object where the top and side edge range are not recognized, the smallest rectangle of the object can be directly outlined to obtain the edge position set {POS}i of the object. After the edge position of the monitoring target is determined, the warning area (the buffer area edge shown in FIG. 11) can be obtained by expanding outwardly according to the predetermined buffer distance L_buff. The position set of the warning area obtained by expansion outwardly can be {POS}i_buff.

In some embodiments, a warning area can include a plurality of sub-areas with a plurality of warning levels. The sub-area of each warning level can correspond to a different buffer distance. For example, if the warning area includes two sub-areas with different warning levels, the first sub-area can correspond to buffer distance L_buff_1, and the second sub-area can correspond to buffer distance L_buff_2. Buffer distance L_buff_1 can be greater than buffer distance L_buff_2. Thus, the position set of the first sub-area can be {POS}i_buff_1, and the position set of the second sub-region can be {POS}i_buff_2.

In some embodiments, the edge position of the warning object can be determined according to the methods of embodiments of the present disclosure. For example, The warning object can include a pedestrian, a bicycle, etc., and the dimension of the warning object in the image can be less than 5*5 pixels. Then, the smallest external rectangle of the warning object can be directly outlined. As shown in FIG. 11, the edge pixels of the smallest external rectangle can be obtained and the position information of the center pixels on the ground to obtain the edge position set {pos} i for the warning object. In some embodiments, a warning area can also be set for the warning object. The warning area can be set according to the method of any embodiment of the object, which is not limited here. If the warning object can have buffer distance 1_buff, the position set of the warning area of the warning object can be {pos}i_buff.

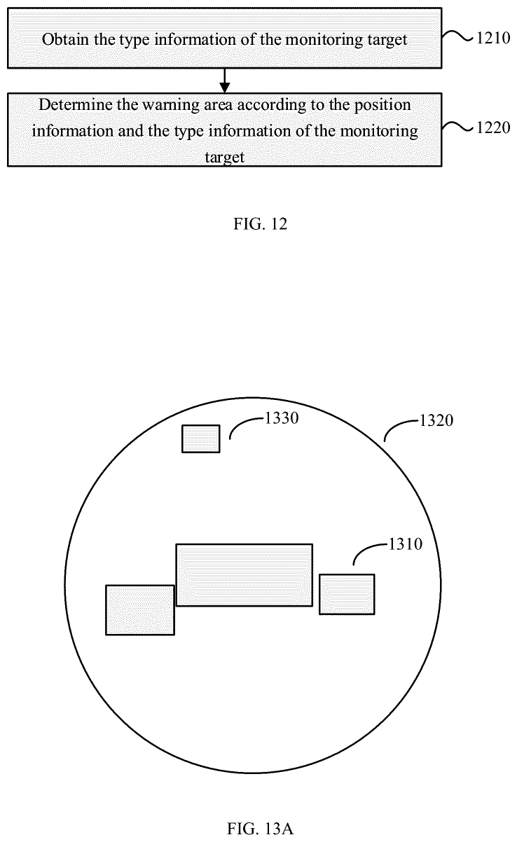

In some embodiments, the monitoring method of the present disclosure further includes the following processes shown in FIG. 12.

At 1210, the type information of the monitoring target is obtained.

At 1220, the warning area is determined according to the position information and the type information of the monitoring target.

In addition to being classified according to the position information of the monitoring target, the warning area can also be determined according to the type information of the monitoring target. The type information of the monitoring target can include a low-risk category, a medium-risk category, and a high-risk category. For example, in an emergency incident, an area where a traffic accident occurs can be classified as the low-risk category, while a fire area can be classified as a high-risk category. For different categories, warning areas with different sizes can be set. For example, the buffer distance set for the monitoring target belonging to the high-risk category can be the largest. The buffer distance set for the monitoring target belonging to the medium-risk category can be the second largest. The buffer distance set for the monitoring target belonging to the low-risk category can be the smallest.

In addition, in some embodiments, one warning area can include a plurality of sub-areas with different warning levels. The sub-areas with different warning levels can correspond to warning information with different levels. For example, the warning area can include a first sub-area and a second sub-area, with sequentially increasing warning levels. For the first sub-area, the warning information can include “You have entered the warning area, please leave immediately.” For the second sub-area, the warning information can include “Please stop approaching and leave the warning area immediately.” Moreover, for the sub-areas with different levels, different warning measures can be adopted. For example, for the first sub-area, a warning measure of audio broadcasting the warning information can be adopted. For the second sub-area, the warning measure of notifying the warning object using an APP, message, or phone call can be adopted.

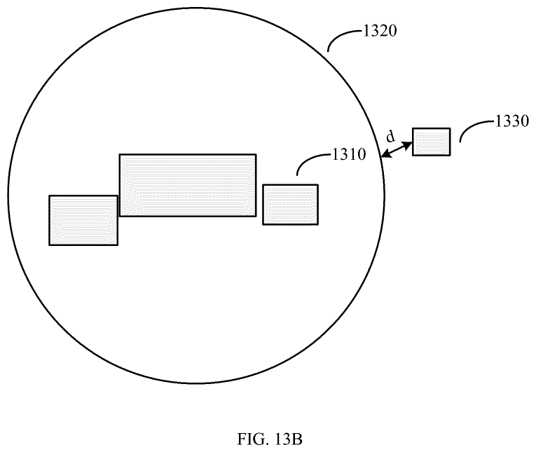

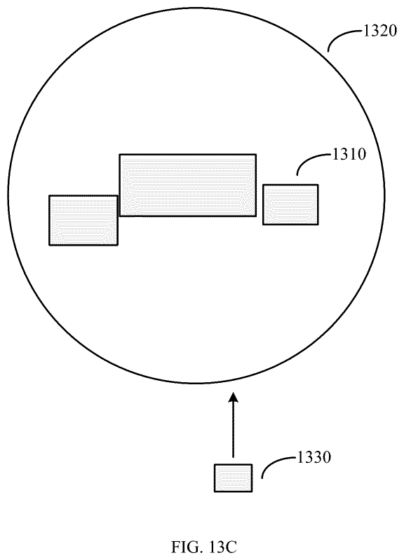

FIGS. 13A to 13C are schematic diagrams showing position relationships between a warning object and a warning area consistent with an embodiment of the present disclosure. When the position relationship between the warning object and the warning area satisfies any one of the relationships, the warning information can be generated.

As shown in FIG. 13A, the monitoring target is a plant area 1310, and the warning area 1320 is a circular area. The boundary rectangle of the warning object 1330 is shown in the figure. When the warning object 1330 is inside the warning area 1320, the warning information can be generated to prompt the warning object 1330 to leave the warning area 1320. In some embodiments, whether the edge position set {pos}i or the position set {pos}i_buff of the warning area of the warning object enters the position set {POS}i_buff of the warning area of the monitoring target can be analyzed to determine whether the warning object enters the warning area of the monitoring target.

In addition, as shown in FIG. 13B, when the distance d between the position of the warning object 1330 and the edge of the warning area 1320 is less than a predetermined distance threshold, the warning information can be generated to prompt the warning object 1330 to stop approaching the warning area 1320. In some embodiments, the distance between the edge position set {pos}i or the position set {pos}i_buff of the warning area of the warning object and the position set {POS}i_buff of the warning area of the monitoring target can be analyzed to determine whether the distance between the position of the warning object and the edge of the warning area of the monitoring target is smaller than the predetermined distance threshold.

Moreover, based on the position information of the warning object, motion information of the warning object can be extracted. According to the motion information, a predicted position of the warning object can be generated. If the predicted position of the warning object and the warning area satisfy a predetermined condition, the warning information can be generated. For example, as shown in FIG. 13C, based on the position information of the warning object 1330, the motion information of the warning object 1330 can be extracted. The motion information of the warning object 1330 can include moving towards the warning area 1320. According to the motion information, the predicted position of the warning object 1330 can be generated. If the predicted position of the warning object 1330 and the warning area 1320 satisfy the predetermined condition, the warning information can be generated. For example, the predetermined condition can include the predicted position being inside the warning area. When the warning object 1330 moves towards the warning area 1320, the predicted position of the warning object 1330 can enter the warning area 1320. Thus, the warning information can be generated to prompt the warning object 1330 to change the moving trajectory.

After the warning information is generated, the warning object can be warned or prompted. In some embodiments, the method can further include sending the position information of the monitoring target to another mobile device to cause the mobile device to perform a target task according to the position information. The target task can include capturing an image of the monitoring target, and/or issuing audio information to the warning object. For example, a monitoring UV can be dispatched to automatically fly to the position of the monitoring to perform reconnaissance or issue audio information.

In some embodiments, the warning object can include a mobile object, e.g., a person and a vehicle. The method can further include controlling the UV to follow the warning object. For example, when the UV hovers at a position in the air to monitor the monitoring target, if a mobile warning object appears in the image collected by the camera apparatus, the UV can follow the warning object. According to the position information of the warning object and the warning area, the warning information can be generated. After the warning object leaves the capturing range of the camera apparatus, the UV can return to the hovering position to continue to monitor the monitoring target.

In some embodiments, the monitoring target can include the mobile object. When the monitoring target is identified to have an abnormally high temperature (e.g., the vehicle is on fire or is at risk of catching fire) by the infrared detector carried by the UV or other detection methods, or the monitoring target is identified to have a dangerous mobile resource (e.g., carrying a dangerous entity), the method can further include controlling the UV to follow the monitoring target. When the mobile monitoring target is on fire or carries a dangerous entity, the UV can be controlled to follow the monitoring target continuously to warn people around the monitoring target to be away from the monitoring target.

In addition, the present disclosure also provides another monitoring method. The method can include, after obtaining the image collected by the camera apparatus carried by the UV, identifying the monitoring target and the warning object in the image through machine learning, determining the position information of the monitoring target and the warning object based on the pose of the camera apparatus when collecting the image, and performing the correction on the position information. Then, by performing feature extraction and machine learning on the image, the top and the side edge range of the monitoring target can be identified, and other traffic tools and people can be identified in the image.

For the monitoring target whose top range can be identified, the position information of the projection points of the edge pixels on the ground can be obtained in sequence to obtain edge position set {POS}i of the monitoring target. For the monitoring target whose top and side edge range cannot be identified, a minimum boundary rectangle of the monitoring target can be directly outlined. The position information of the projection points of the edge pixels and the center pixel of the smallest boundary rectangle on the ground can be obtained to obtain edge position set {POS}i of the monitoring target.

For the warning object in the image with a dimension smaller than 5*5 pixels, the minimum boundary rectangle of the warning object can be directly outlined. Then, the position information of the projection points of the boundary pixels of the minimum boundary rectangle and the projection point of the center pixel on the ground can be obtained in sequence to obtain the edge position set {pos}i of the warning object.

After the edge position of the monitoring target is determined, the warning area can be obtained through outward expansion according to predetermined buffer distance L_buff. The position set of the warning area after expansion can be {POS}i_buff.

The warning area can include at least two sub-areas with different warning levels. The first sub-area can correspond to buffer distance L_buff_1, and the second sub-area can correspond to buffer distance L_buff_2. Thus, the position set of the first sub-area can be {POS}i_buff_1, and the position set of the second sub-area can be {POS}i_buff_2.

Similarly, the warning area can be set for the warning object in the above method. If the buffer distance for the warning object is 1_buff, the position set of the warning area of the warning object can be {pos}i_buff.

Then, real-time analysis can be performed to determine whether edge position set {pos}i of the warning object or position set {pos}i_buff of the warning area of the warning object enters warning area {POS}i_buff of the monitoring target. If not, monitoring can continue. If yes, which sub-area the warning object enters can be determined, the warning information with different levels can correspond to different sub-areas, and different warning measures can be adopted.

After the warning object enters the warning area, the UV can report in real-time to the monitoring device, and the monitoring device can issue a next task scheduling. For example, broadcasting can be performed through a speaker to cause the warning object to leave the warning area, and firefighters/security personnel to be prepared. In addition to the warning messages and countermeasures, the monitoring device can be further configured to send a geographic coordinate of the monitoring target to a monitoring UV to dispatch the monitoring UV to fly to a position near the monitoring target according to the geographic coordinate to perform reconnaissance or issue the audio information.

Thus, the position information of the monitoring target and the warning object can be corrected by the above solution to obtain geographic information and geographic position with higher accuracy. Through real-time machine learning and warning area division, guidance can be quickly provided for on-site operations to effectively respond to emergency incidents. Based on the analysis result, a next operation can be performed, or other devices can jointly perform a coordinating operation to greatly improve the flexibility and intelligence of the security patrols.

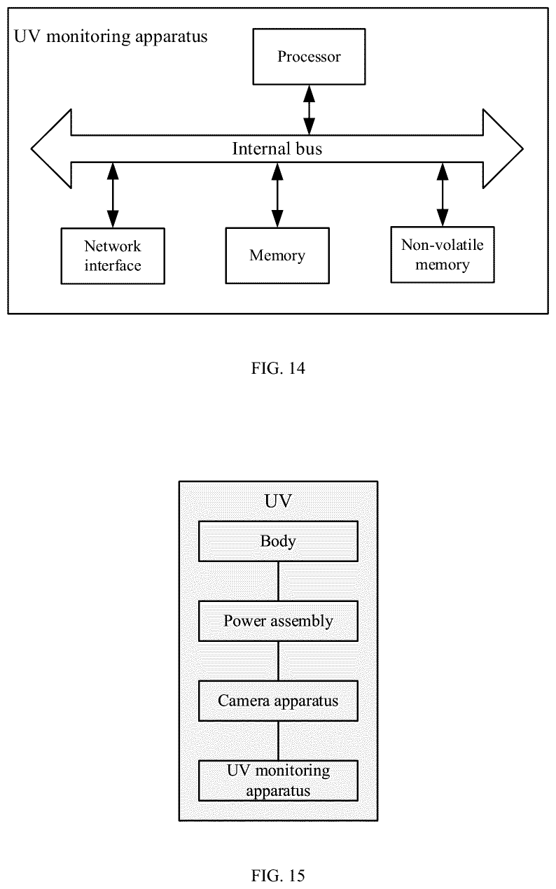

Based on the monitoring method above, FIG. 14 is a schematic structural diagram of a monitoring apparatus consistent with an embodiment of the present disclosure. As shown in FIG. 14, at a hardware level, the monitoring apparatus includes at least one processor, at least one internal bus, at least one network interface, at least one memory, and/or at least one non-volatile memory. The monitoring apparatus can further include hardware required by other operations. The processor can read a corresponding computer program from the non-volatile memory into the memory for execution to realize a monitoring method consistent with the disclosure, such as one of the example monitoring methods described above.

Based on the monitoring method above, FIG. 15 is a schematic structural diagram of a UV consistent with an embodiment of the present disclosure. As shown in FIG. 15, at the hardware level, the UV includes a body, a power assembly configured to drive the UV to move, such as moving in the air, a camera apparatus, and the monitoring apparatus shown in FIG. 14. The monitoring apparatus can include the processor, the internal bus, the network interface, the memory, the non-volatile memory, and/or the hardware required by other operations. The processor can read the corresponding computer program from the non-volatile memory into the memory for execution to realize a monitoring method consistent with the disclosure, such as one of the example monitoring methods described above.

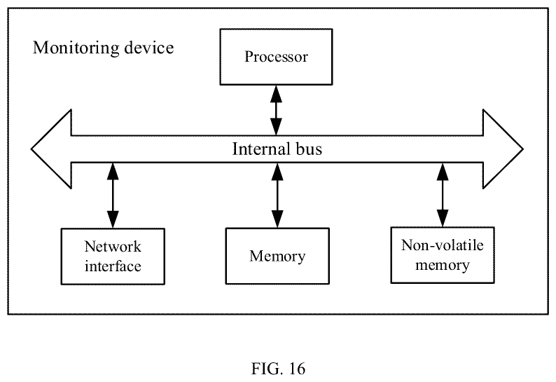

Based on the monitoring method above, FIG. 16 is a schematic structural diagram of a monitoring device consistent with an embodiment of the present disclosure. The monitoring device can communicate with the UV. As shown in FIG. 16, at the hardware level, the monitoring device includes at least one processor, at least one internal bus, at least one network interface, at least one memory, at least one non-volatile memory, and/or hardware required by other operations. The processor can read the corresponding computer program from the non-volatile memory into the memory for execution to realize a monitoring method consistent with the disclosure, such as one of the example monitoring methods described above.

Based on the monitoring method above, the present disclosure further provides a computer program product, including a computer program that, when executed by at least one processor, causes the at least one processor to perform a monitoring method consistent with the disclosure, such as one of the example monitoring methods described above.

Based on the monitoring method above, the present disclosure further provides a computer storage medium storing a computer program that, when executed by at least one processor, causes the at least one processor to perform a monitoring method consistent with the disclosure, such as one of the example monitoring methods described above.

For device embodiments, since device embodiments basically correspond to method embodiments, relevant places can refer to the description of method embodiments. Device embodiments are merely illustrative. A unit described as a separated member can be or not be physically separated. A member displayed as a unit can be or not be a physical unit, i.e., being located at a place or being distributed at a plurality of network units. Some or all modules can be selected according to the actual needs to realize the purpose of the solution of embodiments of the present disclosure. Those skilled in the art can understand and implement without creative efforts.

In the present disclosure, relational terms such as “first” and “second” are used solely to distinguish one entity or operation from another, and do not necessarily imply any actual relationship or sequence between these entities or operations. The terms “comprising,” “including,” or any other variants are intended to cover non-exclusive inclusion, so that processes, methods, entities, or devices comprising a series of elements include not only those elements but also include other elements not explicitly listed, or include the elements inherent to the processes, methods, entities, or devices. Without further limitation, an element limited by the phrase “comprising a . . . ” does not exclude the presence of other identical elements in the processes, methods, entities, or devices including the element.

The methods and apparatuses of embodiments of the present disclosure are described in detail above. Some examples are used to illustrate the principles and embodiments of the present disclosure. The description of embodiments of the present disclosure is only intended to help understand the method and core ideas of the present disclosure. Meanwhile, for those skilled in the art, according to the spirit of the present disclosure, changes can be made to embodiments of the present disclosure and the application range. In summary, the specification of the present disclosure should not be understood as limiting the present application.

What is claimed is:

1. A monitoring method comprising:
identifying a monitoring target and a warning object in space according to data collected by a data collection apparatus;
obtaining position information of the monitoring target and the warning object;
determining a warning area based on the position information of the monitoring target; and
generating warning information based on a position relationship between a position of the warning object and the warning area.

2. The method according to claim 1, further comprising:
obtaining an orthographic image or a stereoscopic image of a target area where the monitoring target is located; and
displaying the warning area in the orthographic image or the stereoscopic image.

3. The method according to claim 2, wherein the orthographic image is an image obtained by synthesizing the data collected by the data collection apparatus.

4. The method according to claim 2, further comprising:
obtaining a three-dimensional model of the target area, the three-dimensional model being created through the data collected by the data collection apparatus;
wherein obtaining the orthographic image includes obtaining the orthographic image through the three-dimensional model.

5. The method according to claim 1, wherein:
the data collection apparatus includes a camera apparatus;
the collected data includes an image; and
obtaining the position information of the monitoring target and the warning object includes:
obtaining the position information of the monitoring target and the warning object when the monitoring target is in a center area of the image.

6. The method according to claim 1, wherein:
the position information of the monitoring target includes a determined position of the monitoring target, and the warning area is determined according to the determined position and a predetermined area model; and/or
the position information of the monitoring target includes an edge position of the monitoring target, and the warning area is determined according to the edge position and a predetermined buffer distance.

7. The method according to claim 6, wherein the edge position is determined through a feature point at an outer surface of the monitoring target.

8. The method according to claim 1, further comprising:
obtaining type information of the monitoring target; and
determining the warning area according to the position information and the type information of the monitoring target.

9. The method according to claim 1, wherein:
the warning area includes a plurality of sub-areas with different warning levels; and
the plurality of sub-areas with different warning levels correspond to warning information of different levels.

10. The method according to claim 1, wherein generating the warning information based on the position relationship includes:
generating the warning information in response to the warning object being in the warning area;
generating the warning information in response to a distance between the position of the warning object and an edge of the warning area being smaller than a predetermined distance threshold; or
extracting motion information of the warning object based on the position information of the warning object, generating a predicted position of the warning object according to the motion information, and generating the warning information in response to the predicted position of the warning object and the warning area satisfying a predetermined condition.

11. The method according to claim 1, further comprising:
sending the position information of the monitoring target to a mobile device to cause the mobile device to perform a target task according to the position information, the target task including capturing an image of the monitoring target and/or issuing audio information to the warning object.

12. The method according to claim 1, wherein:
the warning object includes a mobile object, and the method further includes controlling a mobile platform to follow the warning object; and/or
the monitoring target includes a mobile object, and the method further includes controlling a mobile platform to follow the monitoring target.

13. The method according to claim 1, wherein:
the data collection apparatus includes a camera apparatus;
the collected data includes an image collected by the camera apparatus; and
the position information of the monitoring target and the warning object is determined based on a pose of the camera apparatus when collecting the image.

14. The method according to claim 13, wherein obtaining the position information of the monitoring target includes:
obtaining pixel position information of the monitoring target in the image;
obtaining pose information of the camera apparatus; and
calculating the position information of the monitoring target according to the pixel position information and the pose information.

15. The method according to claim 14, wherein:
the position information of the monitoring target includes horizontal position information and height information; and
obtaining the position information further includes:
looking up a correction value of the height information using a predetermined terrain model according to the horizontal position information; and
updating the horizontal position information using the correction value.

16. The method according to claim 14, wherein performing the correction on the position information of the monitoring target includes:
recognizing a measurement point in the image and obtaining pixel position information of the measurement point;
obtaining the pose information of the camera apparatus;
calculating position information of the measurement point according to the pixel position information and the pose information; and
determining error information based on the position information of the measurement point and actual position information of the measurement point.

17. The method according to claim 16, wherein:
the measurement point is a road sign with known actual position information; or
determining the actual position information of the measurement point includes at least one of:
determining the actual position information of the measurement point based on point cloud information obtained by a laser radar carried by the mobile platform for the measurement point; or
calculating the actual position information of the measurement point based on a visual algorithm.

18. A monitoring apparatus comprising:
one or more processors; and
one or more memories storing one or more executable instructions that, when executed by the one or more processors, cause the one or more processors to:
identify a monitoring target and a warning object in space according to data collected by a data collection apparatus;
obtain position information of the monitoring target and the warning object;
determine a warning area based on the position information of the monitoring target; and
generate warning information based on a position relationship between a position of the warning object and the warning area.

19. The apparatus according to claim 18, wherein:
the data collection apparatus includes a camera apparatus;
the collected data includes an image; and
the position information of the monitoring target and the warning object is determined based on a pose of the camera apparatus when collecting the image.

20. The apparatus according to claim 18, wherein the one or more processors are further configured to:
generate the warning information in response to the warning object being in the warning area;
generate the warning information in response to a distance between a position of the warning object and a position of an edge of the warning area being smaller than a predetermined distance threshold; or
extract motion information of the warning object based on the position information of the warning object, generate a predicted position of the warning object according to the motion information, and generate the warning information in response to the predicted position of the warning object and the warning area satisfying a predetermined condition.
